(19) United States
(12) Patent Application Publication
(10) Pub. No.: US 2005/0008073 A1
(43) Pub. Date: Jan. 13, 2005

(54) Method and device for determining movement in at least two successive digital images, computer readable storage medium and computer program

(76) Inventor: Axel Techmer, Munchen (DE)

Correspondence Address: Altera Law Group, Suite 100, 6500 City West Parkway, Minneapolis, MN, 55344-7704, US

(21) Appl. No.: 10/476,690

(22) PCT Filed: May 2, 2002
(86) PCT No.: PCT/DE02/01585

(30) Foreign Application Priority Data
May 14, 2001 (DE) 10123365.5

(51) Int. Cl. H04N 7/12

(52) U.S. Cl. 375/240.01; 375/240; 348/26

(57) ABSTRACT

An apparatus and method for determining the motion in at least two chronologically successive digital images, the digital images contain pixels which are in each case assigned coding information. Using the coding information, in a first image, at least one contour with a multiplicity of contour pixels situated on the contour is determined. Using the contour pixels situated on the determined contour of the first image, a determination of the motion is carried out with regard to a reference contour with reference contour pixels which is contained in a second image.

The invention relates to a method and an apparatus for determining motion in at least two chronologically successive digital images, a computer-readable storage medium and also a computer program element.

In the context of digital image processing, the determination of motion in chronologically successive images, usually also referred to as motion estimation, is an essential item of information for determining the content of digital images. Thus, by way of example, in the human visual system, too, the determination of the motion of perceived objects is executed as an early processing step in human sensory perception.

In digital image processing, however, determining the image motion is a highly computation-intensive and thus cost-intensive process.

In particular in order to be able to carry out a determination of the image motion in real time and thus to be able to reliably ensure the application of image processing methods in real time applications, in accordance with the prior art, highly cost-intensive hardware elements, for example special graphics processors or graphics cards (principally also image processing cards), have to be used on account of the complexity of the known methods. As an alternative, it is known to carry out the determination of the image motion only on the basis of a few pixels in the digital image, in order thus to save the corresponding computation time.

Methods for determining the image motion in a chronological sequence of digital images which are based on the above mentioned principles are described in [1], [2] and [3].

The use of cost-intensive hardware is very disadvantageous, however, and, moreover, is only possible at all in specific applications.

Moreover, the restriction to individual pixels when determining the image motion has the effect that only a small array of pixels with coding information assigned to the pixels are taken into account in the motion determination, the individual pixels being distributed sparsely over the entire image.

Coding information is to be understood hereinafter as an item of brightness information (luminance information) and/or an item of color information (chrominance information) which are/is in each case assigned to one or more pixels.

However, this small quantity of information taken into account makes the subsequent evaluation of the image information difficult and affected by errors, for example if it is a matter of determining a vehicle as a contiguous object on the basis of the motion information in a sequence of digital images and describing its motion over a plurality of digital images.

Usually, the selected pixels which are taken into account in the context of the motion determination in chronologically successive digital images are defined by means of gray-scale value corners, that is to say by means of pixels situated in a corner region of abrupt transitions in the luminance values assigned to the respective pixels. However, these gray-scale value corners are not necessarily object-specific. This holds true principally at the object boundaries since, at the object boundaries, the gray-scale value corners are determined by the gray-scale value profile of background and object. Since the background need not be uniform in the image, however, the temporal assignment of the gray-scale value corners leads to incorrect motion information in this case.

[4] and [5] describe methods for determining a contour with contour pixels in a digital image with pixels which are assigned coding information.

Moreover, [6] discloses a distance transformation as a morphological operation for determining minimum distances between points of a spatial environment under consideration and a contour with contour pixels. [7] and [8] describe two alternative implementations of the distance transformation from [6].

Furthermore, [9] discloses that it is possible for the entire digital image to be reconstructed again merely from a contour representation of a digital image.

Moreover, [10] describes a method for segmentation of an image sequence in which contour information is determined from segmentation information of objects that have already previously been segmented. Motion information is calculated on the basis of the object-related contour information.

The method described in [11] for determining the motion of objects in a sequence of digitized images uses a statistical model with two components, a static component (for describing the background) and a moving component (for describing moving objects).

The invention is based on the problem of specifying a simplified and thus faster and more cost-effective determination of the motion in a sequence of chronologically successive images.

The problem is solved by means of the method and the apparatus for determining the motion in at least two chronologically successive digital images, the computer-readable storage medium and the computer program element having the features in accordance with the independent patent claims.

In the case of a method for determining the motion in at least two chronologically successive images, the digital images contain pixels which are in each case assigned coding information. Using the coding information, in a first image, at least one contour with a multiplicity of contour pixels situated on the contour is determined. Using the contour pixels situated on the determined contour of the first image, a determination of the motion is carried out with regard to a reference contour with reference contour pixels which is contained in a second image.

An apparatus for determining the motion in at least two chronologically successive digital images has a processor which is set up in such a way that the method steps described above can be carried out.

Stored on a computer-readable storage medium is a program which, after it has been loaded into a memory of a computer, enables the computer to carry out the method steps described above for determining the motion in at least two chronologically successive digital images.

A computer program element has the method steps described above after it has been loaded in a memory of the computer and is executed by the computer for determining the motion in at least two chronologically successive digital images.

Clearly, the invention can be seen in the fact that the determination of the motion on the basis of the determined contour, that is to say contour extracted from a digital image, in a digital image is determined with regard to a reference contour in a chronologically preceding or chronologically succeeding image. According to the invention, the contour information is determined directly from the coding information assigned to the pixels.

Hereinafter, the term contour denotes a contiguous, that is to say a sequence of contour pixels that are spatially adjacent in an image. To put it another way, pixels are contiguous and thus form a contour if they are arranged directly adjacent to one another on the image raster, that is to say in the digital image.

The use of the determined contours and of the contour pixels situated therein in the context of the motion determination in a sequence of digital images permits a temporal stabilization of the motion information determined and, in addition, also the determination and detection even of small movements in the sequence of chronologically successive digital images. This is made possible in particular by virtue of the fact that, by means of the determination of the contours and the taking account of the contours in the motion determination, a temporal integration is usually carried out over the clearly defined area explained hereinafter which is formed by the displacement of contours in chronologically successive digital images between the two contours taken into account.

This is advantageous in particular for the motion determination in the far field of a video sequence, that is to say, in particular, in the image background of a sequence of digital images.

On account of the perspective, movements in the far field of a video sequence, that is to say movements between two successive digital images, usually lie below the image resolution and thus often cannot even be determined in the first place by means of the methods that are usually carried out.

Furthermore, the highly targeted selection of pixels taken into account in the context of the motion determination, namely the taking account of contour pixels determined previously in a first extraction step, has the effect of enabling a determination of the motion even in real time applications with the use of customary personal computers without additional complex special hardware.

In this connection, it should be noted that real time is not an unambiguously defined performance term. Hereafter, real time is understood to be a processing time which is essentially shorter than 40 ms. A time interval of 40 ms corresponds to the time offset of two digital individual images of an analog video sequence.

Preferred developments of the invention emerge from the dependent claims.

The refinements of the invention described below apply to the method, the apparatus, the computer program element and to the computer-readable storage medium.

In accordance with one refinement of the invention, using the coding information, in the second image, at least one reference contour with a multiplicity of reference contour pixels situated on the contour is determined.

The motion determination may be carried out both proceeding from a chronologically preceding image and proceeding from a chronologically succeeding image, that is to say it is possible to carry out both a motion prediction and a motion determination in temporally retrospective consideration.

To put it another way, this means that the second image as reference image with the reference contour may be the chronologically preceding or else chronologically succeeding image with respect to the first image with the extracted contour that is taken into account in the image motion.

In the determination of the image motion, a minimum distance image, that is to say clearly a field of values which in each case specify a minimum distance between a pixel in the minimum distance image and a reference contour pixel, may be determined for the reference contour and the reference contour pixels situated on the reference contour by means of a morphological operation.

A distance transformation may be used as the morphological operation, it having been found that, in particular, the distance transformation described in [6] is highly suitable and leads to very good results.

In accordance with one refinement of the invention, a minimum distance value for a reference contour pixel at an instant t with respect to a pixel in a distance image is determined in accordance with the following specification:

$${D}_{\underline{v} ( l )} ( x , y , t ) = {min}_{l} ‖ {[ x , y ]}^{T} - {\underline{v}}^{′} ( l , t ) ‖ ,$$

where
Dᵥ₍₁₎ (x, y, t) denotes a minimum distance value between the pixel [x, y] and a reference contour pixel on the reference contour in the second image,
[x, y] denotes a pixel in the distance image,
v′(1, t) denotes a reference contour pixel in the second image,
1denotes a reference contour pixel index for unambiguously identifying a reference contour pixel on the reference contour in the second image,
t denotes an instant at which the determination is carried out.

In accordance with a further refinement of the invention, it is advantageous additionally to take account of the contour direction, that is to say the direction in which the contrast alteration runs along a contour.

This refinement of the invention further increases the reliability of the motion determined.

The invention is suitable in particular for use in the area of detecting moving objects in a scenario which involves distinguishing a multiplicity of moving objects from one another and from nonmoving objects.

A highly suitable field of use is, in particular, traffic monitoring or determining the motion in scenes which are recorded by a digital camera installed in a moving vehicle.

An exemplary embodiment of the invention is illustrated in the figures and is explained in more detail below.

In the figures:

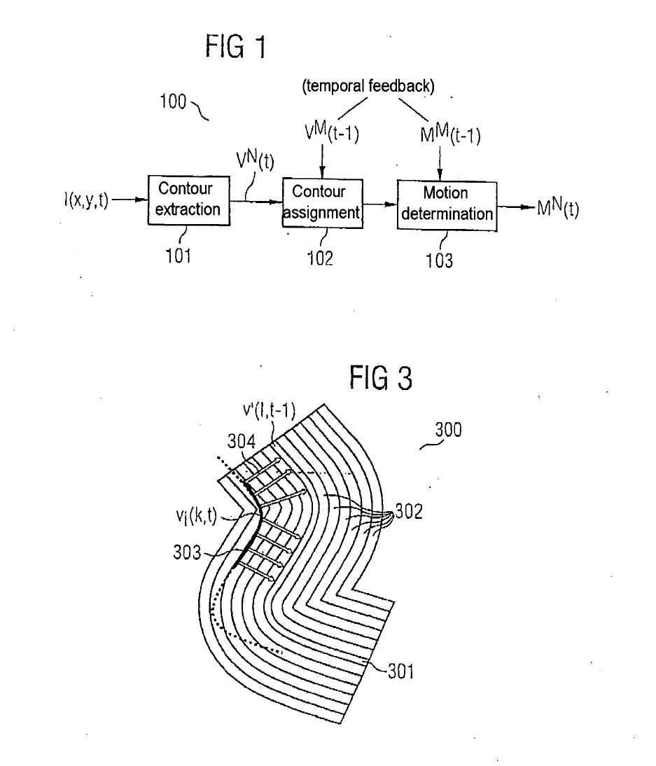

FIG. 1 shows a block diagram illustrating the individual method steps of the determination of the image motion in accordance with an exemplary embodiment of the invention;

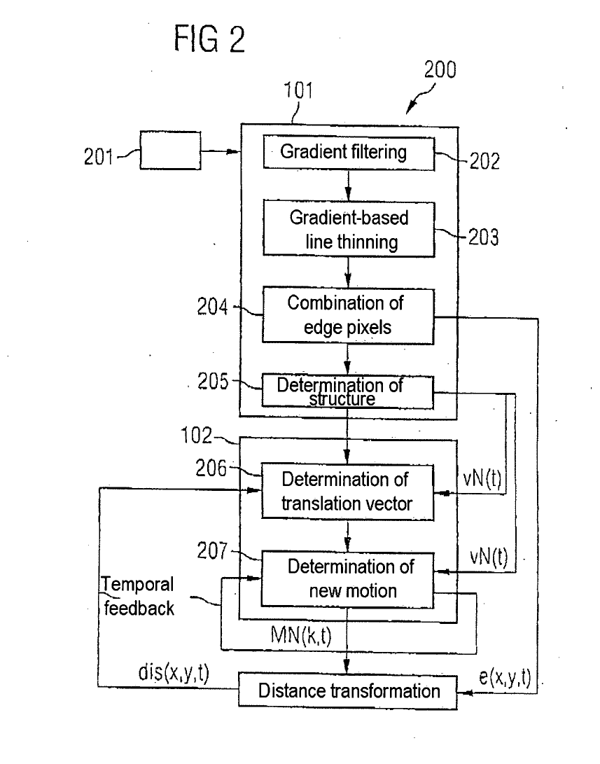

FIG. 2 shows a flow diagram illustrating in detail the method steps for determining the image motion in accordance with an exemplary embodiment of the invention;

FIG. 3 shows an illustration of a distance image with a reference contour, with contour lines assigned to the reference contour, and also with a contour;

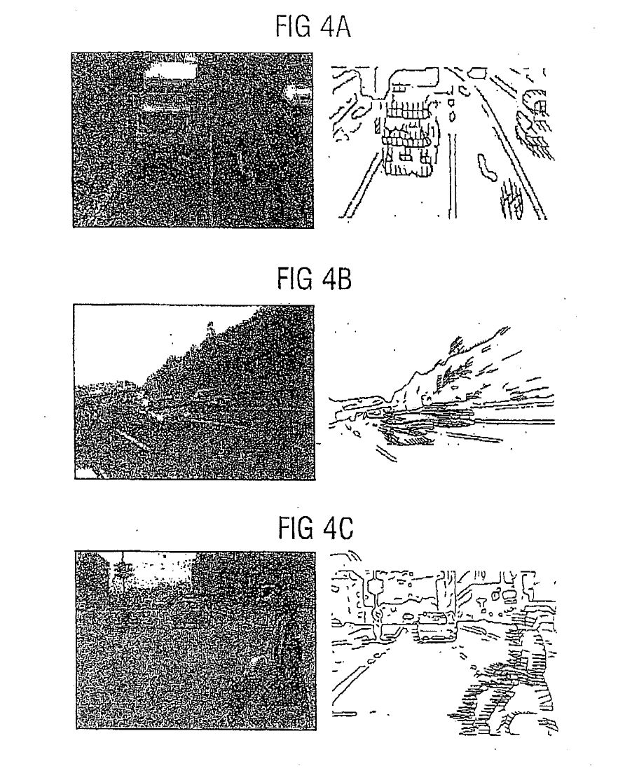

FIGS. 4a to 4c show results of the contour-based motion determination according to the invention for various scenes.

In accordance with the exemplary embodiment, a digital camera is installed on a vehicle and records a recording region in the direction of travel of the moving vehicle.

Consequently, a sequence of digital images is generated by means of the digital camera, each digital image having a multiplicity of pixels and coding information assigned to the pixels, brightness values assigned to the pixels in accordance with this exemplary embodiment.

A brightness value which is assigned to a digital image identified by a pixel characterized by two coordinates x and y at an instant t is designated by I (x, y, t) (cf. FIG. 1).

In accordance with this exemplary embodiment, a contour extraction is carried out using the brightness values I (x, y, t) for a respective digital image, referred to hereinafter as first digital image in accordance with this exemplary embodiment. To put it another way, contours are determined for the first image (block 101 in the block diagram 100 in FIG. 1).

This is done by detecting edges in the digital image. Edges mark contrast jumps in the profile of the brightness information in the digital image.

As already explained above, hereinafter contiguous chains of contour points, that is to say as contiguous edges, that is to say as a contiguous sequence of contour points that are spatially directly adjacent, are referred to as contours.

In accordance with this exemplary embodiment of the invention, the method described in [4], and as an alternative thereto the method described in [5], is carried out for the purpose of contour extraction.

FIG. 2 shows the step of contour extraction 101 for a digital image 201 in detail in a flow diagram 200.

In accordance with the flow diagram 200 illustrated in FIG. 2, a gradient filtering (step 202) and then a gradient-based line thinning (step 203) are carried out for the digital image 201.

In a further step, determined edge pixels e (x, y, t) of determined lines in the digital image 201 are combined with one another and a contour, in the general case a multiplicity of N contours, is determined in each digital image 201 (step 205).

Consequently, as a result of the contour extraction 101, in accordance with this exemplary embodiment of the invention, a data structure v^{N}(t) is present in which the N extracted contours in the digital image 201 taken into account are contained and stored, which may subsequently be accessed directly.

The contour assignment is effected in a further step (step 102 in FIG. 1).

In the context of the contour assignment 102, for each determined contour point of a contour v^{N}(t), there is determined a corresponding point in a reference contour in a chronologically preceding digital image, that is to say a reference contour pixel. The reference contour pixel is situated on a reference contour in the chronologically preceding image. v^{M}(t−1) thus designates the contour structure determined in the preceding time step.

Generally, the correspondence for each contour pixel of the contour is expressed by means of a displacement vector, also called translation vector.

What is intended to hold true for the translation vector is that the contour environment can be mapped as well as possible onto reference contour pixels from the preceding digital image by means of the respective translation vector.

The assumption used is that the temporal alteration of contours is described to an approximation by a translation. The displacement is optimal when the sum of the minimum distances between points of the contour environment considered and reference contour pixels of the reference contour v^{M}(t−1) becomes minimal.

In order to determine the minimum distances, according to the invention use is made of a morphological operation, the distance transformation described in [6] in accordance with this exemplary embodiment.

For further illustration, FIG. 3 shows the principle of the assignment for two chronologically successive contours, that is to say for contours from two chronologically successive images for which a motion determination is carried out in each case. FIG. 3 shows a distance image 300 with a reference contour 301, and also with contour lines 302 formed by means of the distance transformation described in [6]. Hereinafter, contour lines are understood to be those lines in the distance image which have a constant minimum distance from the reference contour, i.e. from a reference contour pixel on the reference contour.

The distance transformation is carried out for each reference contour which is taken into account in the context of the motion determination. The result of the distance transformation—explained in detail hereinafter—applied to the reference contour v′(l, t−1) is illustrated by means of the contour lines 302 in FIG. 3.

The environment vᵢ(k, t) of a pixel in the minimum distance image 300 which is formed by means of the distance transformation and is illustrated in FIG. 3 is displaced for motion determination purposes with regard to a contour 303 for which the motion is intended to be determined.

For each of these displacements, at each contour point it is possible to specify the minimum distance from the reference contour v ′(l, t−1) using the contour line 302.

The minimum sum of these determined distances then leads to the optimum displacement, approximately to the optimum translation, illustrated in symbolized form in FIG. 3 by means of translation vectors 304.

This principle of contour assignment has the advantage over direct comparison of contours that errors in the contour detection have a lesser influence on the quality of the motion determination. This is of importance in particular when contours are incomplete or interrupted in their course.

The contour assignment 102 is explained in greater detail hereinafter. In the second block illustrated in FIG. 2, that is to say the in the block of contour assignment 102, the actual motion along the contours is calculated.

In order to enable an efficient processing of the contours in the context of the digital image processing, the image representation is subsequently converted into a data structure which enables direct access to contours as a chain of contour points.

Consequently, for the purpose of contour representation, each contour is designated by vⁿ(t). The contour index n is a natural number in the range of between 1 and N, where N denotes the number of contours contained in the data structure.

The generation of the contour structure is followed, in a further step, by the temporal assignment of the contours.

In the context of the contour assignment, an optimum assignment is determined for each contour point.

If two chronologically successive contours, that is to say a contour in a first image v(k, t) and a reference contour v(l, t−1), are considered, then the optimization criterion described above is formulated in accordance with the following energy minimization:

$$E ( {\underline{T}}_{i} ) = {\sum }_{k = {k}_{i0}}^{k = {k}_{it}} {min}_{l} ‖ {\underline{v}}^{′} ( l ) - {( {\underline{v}}_{i} ( k ) + {\underline{T}}_{i} )}^{2} ‖ , \qquad ( 1 )$$

where
i denotes a translation vector index for unambiguously identifying a translation vector,
Tᵢ denotes an i-th translation vector,
vᵢ(k) denotes a contour pixel in the first image,
k denotes a contour pixel index for unambiguously identifying a contour pixel in the first image,
v′(l) denotes a reference contour pixel in the second image,
l denotes a reference contour pixel index for unambiguously identifying a reference contour pixel on the reference contour in the second image,
kᵢ₀ denotes a first reference contour pixel,
kᵢₜ denotes a second reference contour pixel, and
E (Tᵢ) denotes a minimum energy value.

In accordance with specification (1), the differential area between two contours, that is to say between the contour v(k, t) and the reference contour v(l, t−1), is approximated by means of the sum of the minimum distances.

The optimum translation results from the minimum energy E (Tᵢ) as:

$${\hat{\underline{T}}}_{i} = arg {min}_{{\underline{T}}_{i}} E ( {\underline{T}}_{i} ) , \qquad ( 2 )$$

where \hat{T}ᵢ denotes an optimum translation.

With the aid of the distance transformation as is explained in more detail hereinafter, the minimum distances are determined very efficiently.

The distance transformation which is applied to the reference contour v(l, t−1) in accordance with the method described in [6] is used to generate a minimum distance image 300 with minimum distance values Dᵥ₍ₗ₎(x, y, t−1) as is illustrated by way of example in FIG. 3.

Each image value, i.e. each minimum distance value Dᵥ₍ₗ₎(x, y, t−1), in the distance image 300 contains the information of the minimum distance, that is to say, to put it another way, the minimum distance value Dᵥ₍ₗ₎(x, y, t−1) of a pixel in the minimum distance image 300 with respect to a reference contour pixel of the reference contour v(l, t−1).

The distance transformation is applied in accordance with the following specification to each reference contour point and the corresponding pixel in the distance image Dᵥ₍ₗ₎(x, y, t−1) 300 in accordance with:

$${D}_{\underline{v} ( l )} ( x , y , t - 1 ) = {min}_{l} ‖ {[ x , y ]}^{T} - {\underline{v}}^{′} ( l , t - 1 ) ‖ , \qquad ( 3 )$$

where
Dᵥ₍ₗ₎(x, y, t−1) denotes a minimum distance value between the pixel [x, y] and a reference contour pixel on the reference contour in the second image,
[x, y] denotes a pixel in a distance transformation image,
t denotes an instant,
v′(1) denotes a reference contour pixel in the second image, and
1 denotes a reference contour pixel index for unambiguously identifying a reference contour pixel on the reference contour in the second image.

Thus, specification (1) can be converted into the following specification:

$$E ( {\underline{T}}_{i} ) = {\sum }_{k = 0}^{K - 1} {( {D}_{{\underline{v}}^{′} ( l )} ( \underline{v} ( k ) + {\underline{T}}_{i} ) )}^{2} . \qquad ( 4 )$$

This clearly means that the energies are determined by the contour for which the determination is to be determined with account taken with regard to the reference contour being displaced via the distance image 300, that is to say via the function, that is to say the minimum distance values D_{v (l)}(x, y, t−1) n the distance image 300 and, for each displacement, that is to say translation, the distance values being read from the distance image, that is to say being determined and summed.

Consequently, in specification (4), the minimum distance is calculated only once during the generation of the distance image 300.

This is a considerable simplification compared with the approximation in accordance with specification (1) that is to be determined for each pixel, since in (1) it is necessary to determine the distance for each translation.

In order to temporally stabilize the motion information along the respective contour or the contour pixels, an unambiguous assignment of predecessor contour and successor contour is determined.

This is done, according to the invention, through a modification of specification (4), so that, according to the invention, the following specification results for determining the respective energy:

$$E ( {\underline{T}}_{i} ) = \{ \begin{matrix}{\sum }_{k = 0}^{K - 1} {( {D}_{{\underline{v}}^{′} ( l )} ( \underline{v} ( k ) + {\underline{T}}_{i} ) )}^{2} & if {D}_{{\underline{v}}^{′} ( l )} ( \underline{v} ( {k}_{i} ) + {\underline{T}}_{i} ) = 0 \\ MAX\_VALUE & otherwise\end{matrix} . \qquad ( 5 )$$

Specification (5) clearly means that energies are only determined if the translation vector Tᵢ points to a contour point in the predecessor image, that is to say to a reference contour pixel. Otherwise, the respective energy value is set to a maximum, predetermined value (MAX_VALUE).

After a reference contour pixel and thus a corresponding optimum translation vector has been determined for each contour pixel (step 206), a new stabilized motion is calculated for the individual contour pixels (step 207).

This is possible by storing the translation values from the past, that is to say from preceding motion determinations.

Tᵢ^{L}(t) denotes the L past translations which are known via the predecessor reference contour pixels.

The new motion is then determined for example by means of averaging. To put it another way, a temporal feedback is effected during the determination of the respective translations.

The following method steps are carried out for the averaging. In a first step, the average displacement

$${\underline{m}}_{i} ( t ) = \frac{1}{L + 1} \cdot ( {\hat{\underline{T}}}_{i} + {\underline{T}}_{i}^{0} ( t - 1 ) + … + {\underline{T}}_{i}^{L - 1} ( t - 1 ) ) \qquad ( 6 )$$

is calculated.

Furthermore, the new past translation estimations, that is to say the new translation vectors, are stored in accordance with the following specification:
Tᵢ^{L}(t)=└\hat{T}ᵢ,Tᵢ⁰(t−1), . . . ,Tᵢ^{L-2}(t−1)┘. (7)

As an alternative, the motion can be determined by recursively filtering the determined translation vectors in accordance with the following specification:
mᵢ(t)=mᵢ(t−1)+α·(mᵢ(t−1)−\hat{T}ᵢ) (8)

The recursive filtering has the advantage that it requires less memory space.

As the final processing step, in accordance with this configuration of the invention, the contour is transferred into the distance image, so that the value at each pixel in the distance image corresponds to the minimum distance from a contour pixel in accordance with the following specification:

$${D}_{\underline{v} ( l )} ( x , y , t - 1 ) = {min}_{l} ‖ {[ x , y ]}^{T} - \underline{v} ( l , t - 1 ) ‖ . \qquad ( 8 )$$

As an alternative, it is possible to implement the distance transformation in accordance with the methods described in [7] and [8].

The method described in [6] is briefly presented below.

The presentation serves in particular for explaining the numerical complexity in implementing the method described above.

In order to determine the distance transformation, it is necessary occasionally to consider distance values between the respective pixels which are spatially relatively far away from one another on the image raster, that is to say in the respective digital image considered.

The calculation of the distance values is thus a relatively numerically complex operation.

Instead of determining all possible distance values with respect to contour pixels for a pixel and relating them to one another, exclusively local distances are considered in the distance transformation.

However, the true Euclidean distance can only be approximated in this way. The parallel variant of the distance transformation described in [6] has the following formal structure.

Firstly, a local mask is shifted iteratively over the distance image. At the position of the mask center, the new distance value in the distance image with respect to the reference contour is calculated in accordance with the following specification:

$${D}^{n} ( x , y ) = {min}_{\underline{u} , \underline{v} ∈ mask} ( {D}^{n - 1} ( x , y ) + mask ( \underline{u} , \underline{v} ) ) . \qquad ( 9 )$$

In this case, a respective iteration step is unambiguously identified by n. D⁰(x, y) denotes the inverted distance image.

What is achieved in this way is that initially at the contour pixels, the image value which corresponds to the distance value is present with the value “0” and all the remaining image values have a constant value greater than the maximum distance to be expected.

The local mask is designated by mask (u,v). The mask values correspond to the local distance values of the pixels at the respective mask positions with respect to the mask center.

In accordance with [6], the optimum local distance values are determined for different mask sizes, so that the resulting distance values deviate as little as possible from the true Euclidean distance.

In this case, it holds true, in principle, that the larger the mask, the smaller the deviation, that is to say the numerical error.

Depending on the distance transformation, that is to say on the distance image, the motion determination 103 comprising temporal feedback is effected in a final step, which motion determination uses the result of the contour assignment over a plurality of chronologically successive images. In the context of determining the image motion, the contour assignment 102 is utilized in order to temporally stabilize the motion of the contours. As a result of this step, a motion vector is specified for each contour pixel.

M^{N}(k, t) denotes the set of all motion vectors at each contour pixel at an instant t.

FIGS. 4a to 4c show results of the implementation of the motion determination presented above. The total processing time on a Pentium III with 650 MHz is approximately 20 ms for an image size of 128 lines by 128 columns.

However, the precise processing time is connected with the number of contour pixels to be processed.

A few alternatives to the exemplary embodiment explained above are explained below.

It should be noted that the object contours can be tracked continuously from the entry of an object into a monitored recording region, that is to say a recording region recorded by a digital camera, through to its leaving said region. As a result, for example for automatic acquisition of traffic data, it is possible directly to determine the times for which vehicles stay in the recording region and to take them into account for example in the prognosis of congestion or else in the context of collision avoidance for vehicles.

The contour assignment as has been described above is initially based only on the evaluation of the distance values and thus on the form of the contour itself.

Parallel contour profiles often occur, however, in the case of many technical objects, for example in the case of road markings or road signs. Consequently, the form alone may not always represent an unambiguous criterion. Consequently, an additional item of information is added as an alternative to the contour form, namely the contour direction, which specifies the direction in which the contrast jumps in the respective contour.

The contour direction is automatically determined with the contour generation. In the case of a white road marking, a gray-scale value change is made from dark to light and back to dark again. The left and right edges of the respective contour then run parallel, but they have an opposite contour direction.

In order to utilize the contour direction as an additional feature, the procedure is as follows:
The direction information of v^{M}t−1 is dilated in a manner similar to the distance transformation.
In the summation of the distance values, the cases in a cost function are penalized, that is to say assessed negatively, for which the direction of the current contour point does not match to the dilated direction.

The invention clearly specifies a highly advantageous compromise between data reduction and retention of the essential image information in a sequence of digital images.

As described in [9], it is even possible to reconstruct the entire digital image again from a contour representation.

The invention clearly represents, on account of the use of contours for motion determination, a correlation-based approach which, in particular with regard to segmentation errors, is significantly more robust than the known methods that are merely pixel-based.

In addition, a highly efficient implementation of the invention is specified on account of by means of the distance transformation.

1. A method for determining the motion in at least two chronologically successive digital images with pixels which are assigned coding information, comprising:
determining, using the coding information, in a first image, at least one contour with a multiplicity of contour pixels situated on the contour ;and
carrying out, using the contour pixels situated on the determined contour of the first image, the motion determination with regard to a reference contour with reference contour pixels which is contained in a second image.

2. The method as claimed in claim 1, further comprising determining, using the coding information, in the second image, at least one reference contour with a multiplicity of reference contour pixels situated on the contour is determined.

3. The method as claimed in claim 1 or 2, further comprising:
determining, in the context of the motion determination, minimum distance values between pixels of a distance image and the reference contour by means of a morphological operation [[,]]; and
storing the minimum distance values.

4. The method as claimed in claim [[3]] 1 or 2, further comprising using a distance transformation as the morphological operation.

5. The method as claimed in claim 1 or 2, further comprising determining a minimum distance value D_{v (1)}(x, y, t−1) for a contour pixel v′(1, t) at an instant t with respect to a pixel (x, y) in accordance with the following specification:
$${D}_{\underline{v} ( l )} ( x , y , t ) = {min}_{l} ‖ {[ x , y ]}^{T} - {\underline{v}}^{′} ( l , t ) ‖ ,$$
where
D_{v (1)}(x, y, t) denotes a minimum distance value between the pixel [x, y] and a reference contour pixel on the reference contour in the second image,
x, y] denotes a pixel in the distance image,
v′(1, t) denotes a reference contour pixel in the second image,
1 denotes a reference contour pixel index for unambiguously identifying a reference contour pixel on the reference contour in the second image [[,]] ; and
t denotes an instant at which the determination is carried out.

6. The method as claimed in claim 1 or 2, further comprising accounting for which the contrast direction in which the contrast alteration runs along a contour during the motion determination.

7. An apparatus for determining the motion in at least two chronologically successive digital images with pixels which are assigned coding information, having a processor which is set up in such a way that the following method steps can be carried out:
using the coding information, in a first image, at least one contour with a multiplicity of contour pixels situated on the contour is determined, and
using the contour pixels situated on the determined contour of the first image, a motion is carried out with regard to a reference contour with reference contour pixels which is contained in a second image.

8. A computer program element which, after it has been loaded into a memory of the computer and is executed by a processor of the computer, has the following steps for determining the motion in at least two chronologically successive digital images with pixels which are assigned coding information:
using the coding information, in a first image, at least one contour with a multiplicity of contour pixels situated on the contour is determined, and
using the contour pixels situated on the determined contour of the first image, a motion is carried out with regard to a reference contour with reference contour pixels which is contained in a second image.

9. A computer-readable storage medium on which a program is stored which, after it has been loaded into a memory of a computer, enables the computer to carry out the following steps for determining the motion in at least two chronologically successive digital images with pixels which are assigned coding information:
using the coding information, in a first image, at least one contour with a multiplicity of contour pixels situated on the contour is determined, and
using the contour pixels situated on the determined contour of the first image, a motion is carried out with regard to a reference contour with reference contour pixels which is contained in a second image.
